(19) United States
(12) Patent Application Publication
(10) Pub. No.: US 2023/0251504 A1
(43) Pub. Date: Aug. 10, 2023

(54) TEMPLE FOR EYEGLASSES

(71) Applicant: LUXOTTICA S.R.L., AGORDO (IT)

(72) Inventors: Diego NICOLIS, GREZZANA (IT); Alex RENON, VOLTAGO AGORDINO (IT); Fabio BORSOI, VITTORIO VENETO (IT)

(21) Appl. No.: 18/015,194

(22) PCT Filed: Jul. 7, 2021
(86) PCT No.: PCT/IB2021/056087

§ 371 Date: Jan. 9, 2023

(30) Foreign Application Priority Data
Jul. 9, 2020 (IT) 102020000016618

(51) Int. Cl. G02C 5/14; G02C 11/00

(52) U.S. Cl. CPC G02C 5/14; G02C 11/10

(57) ABSTRACT

A temple for eyeglasses, including a temple body which is provided internally with a cavity for accommodating electronic components. The cavity is accessible via an opening formed at the lower surface of the temple body. The temple further includes a covering element adapted to close the cavity by insertion in the cavity.

### CROSS-REFERENCE TO RELATED APPLICATIONS

This application is a National Stage application of PCT/IB2021/056087, filed on Jul. 7, 2021, which claims priority to Italian application no. 102020000016618, filed on Jul. 9, 2020, all the contents of which are herein incorporated by reference in their entirety.

### TECHNICAL FIELD

The present disclosure relates to a temple for eyeglasses. More particularly, the disclosure relates to a temple for eyeglasses adapted to accommodate electronic components for so-called “electronic” eyeglasses.

### BACKGROUND

As is known, in the field of eyewear so-called “electronic” eyeglasses have long been undergoing development and integrate video camera/still camera functions, temperature and humidity sensors and other functions which can, for example, allow to view significant data on the lens of the eyeglasses.

Eyeglasses of the electronic type obviously require the presence of electronic components which normally must be concealed in order to not modify the aesthetics of the eyeglasses, thus avoiding making it scarcely attractive for the consumer.

The electronic components are normally accommodated mainly in the temples of the eyeglasses, rather than in the front of said eyeglasses. The housing of the electronics in the temples of the eyeglasses occurs, more commonly, by creating an opening at the inner side of the temple, i.e., the side that is designed to be in contact with the face of the user, so as to make it extremely not visible.

The opening formed on the internal surface of the temple allows to accommodate the required electronic components inside the temple.

The electronic components can be, by way of non-limiting example, battery, sensors, RFIDs, PCBs and in general components for the actuation and control of the device.

The opening is then closed by a cover which is glued so as to complete the internal surface of the temple, avoiding, in general, protruding parts.

Furthermore, in the particular case of eyeglasses designed to be worn by children, it is extremely important that the child, or the user in general, may never be able to come into contact with the electronic components accommodated within the eyeglasses, and therefore the presence of a closing cover and of a cavity formed inside the temple, which is usually screwed, do not ensure complete inaccessibility of the electronics, since the user might be induced to unscrew screws and open the closing cover of the cavity. Furthermore, the cover is more often glued and the most common risk is the delamination of the two parts that compose the temple.

In the case of a cover arranged on a lateral face of the temple, the shell of the temple that is affected by the cover is most likely more rigid than the one without the cover, or in any case, with a different deformation and this might lead to a delamination of the two assembled shells which together constitute the body of the temple.

On the other hand, in other embodiments the electronics are accommodated in a sealed external component, which is however applied to the temple of the eyeglasses, therefore protruding therefrom, being aesthetically unsightly and entailing an inconvenience for the user of the eyeglasses due to the protruding part.

### SUMMARY

The aim of the present disclosure is to provide a temple for eyeglasses which can incorporate inside it electronic components necessary for the eyeglasses, so that they are inaccessible for the user.

Within this aim, the present disclosure provides a temple for eyeglasses which allows the electronic components contained therein to be protected from water and dust.

The present disclosure also provides a temple for eyeglasses that meets the requirements of tightness and impermeableness to water of the CEI EN 60529 standard.

the disclosure further provides a temple for eyeglasses that allows to accommodate the electronic components inside it without having significant impacts on the aesthetics of said temple.

The present disclosure provides a temple for eyeglasses in which the deformation at right angles with respect to the length of the temple does not have negative impacts on the element for closing the cavity for accommodating the electronics.

Not least of the present disclosure is to provide a temple for eyeglasses that is highly reliable, relatively easy to provide and at competitive costs.

This aim and these and other advantages which will become better apparent hereinafter are achieved by providing a temple for eyeglasses, comprising a temple body which is provided internally with a cavity for accommodating electronic components, characterized in that said cavity is accessible via an opening formed at the lower surface of said temple body, a covering element being adapted to close said cavity by insertion in said cavity.

### BRIEF DESCRIPTION OF THE DRAWINGS

Further characteristics and advantages of the disclosure will become better apparent from the description of preferred but not exclusive embodiments of the temple for eyeglasses according to the disclosure, illustrated, by way of non-limiting example in the accompanying drawings, wherein:

FIG. 1 is an exploded perspective view of eyeglasses with the temple and the corresponding components according to the present disclosure;

FIG. 2 is a view of the eyeglasses of FIG. 1 in an assembled configuration;

FIG. 3 is an exploded lateral elevation view of the temple for eyeglasses according to the present disclosure;

FIG. 4 is a longitudinal sectional view of the temple for eyeglasses according to the present disclosure;

FIG. 5 is an exploded perspective view of the temple according to the present disclosure;

FIG. 6 is a longitudinal sectional view of a second embodiment of the temple according to the present disclosure; and

FIG. 7 is a transverse sectional view of a further embodiment of the temple according to the disclosure.

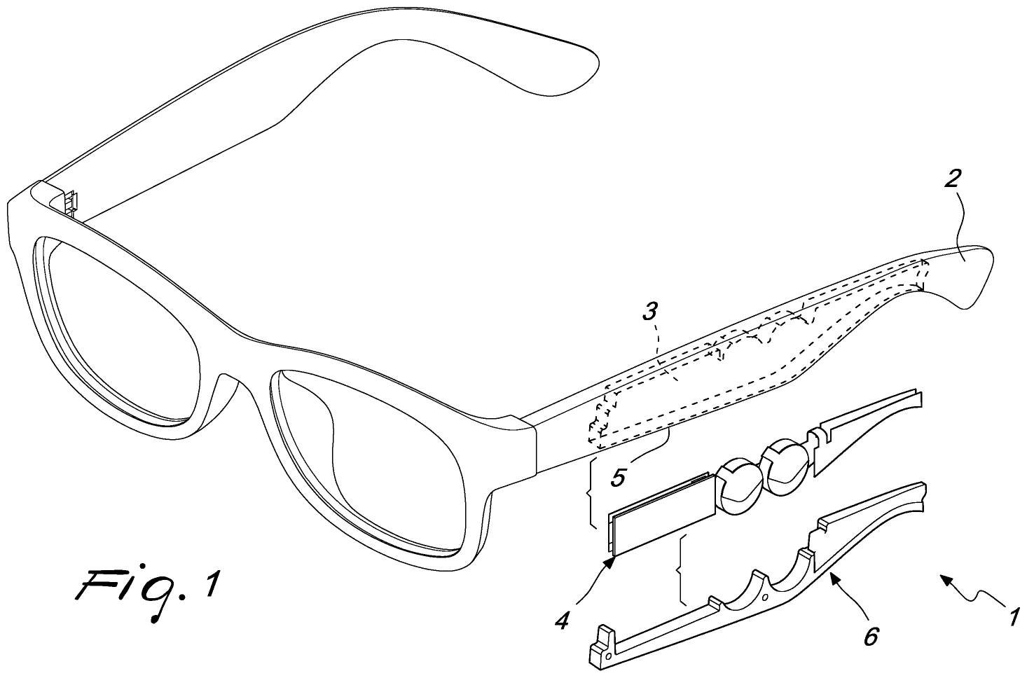

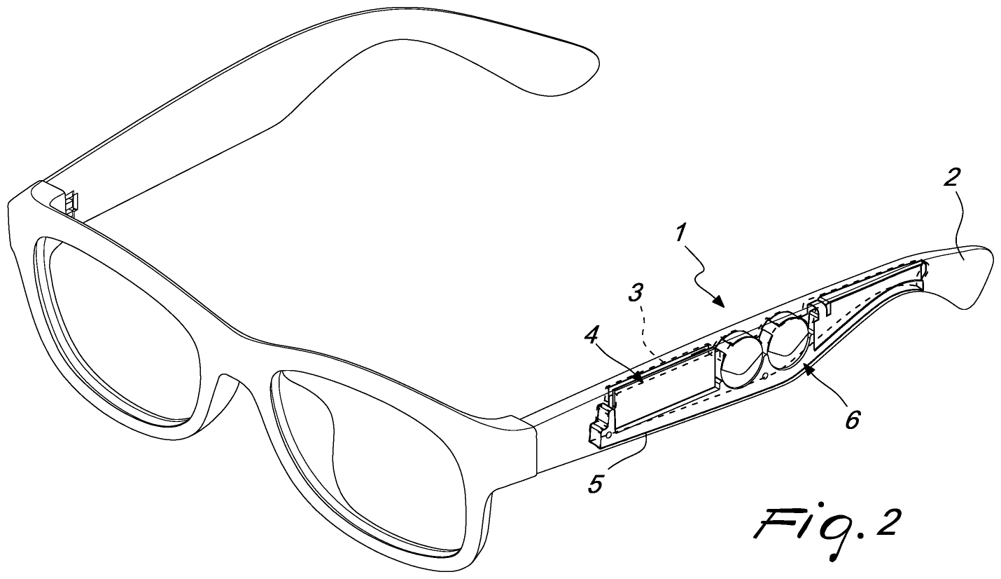

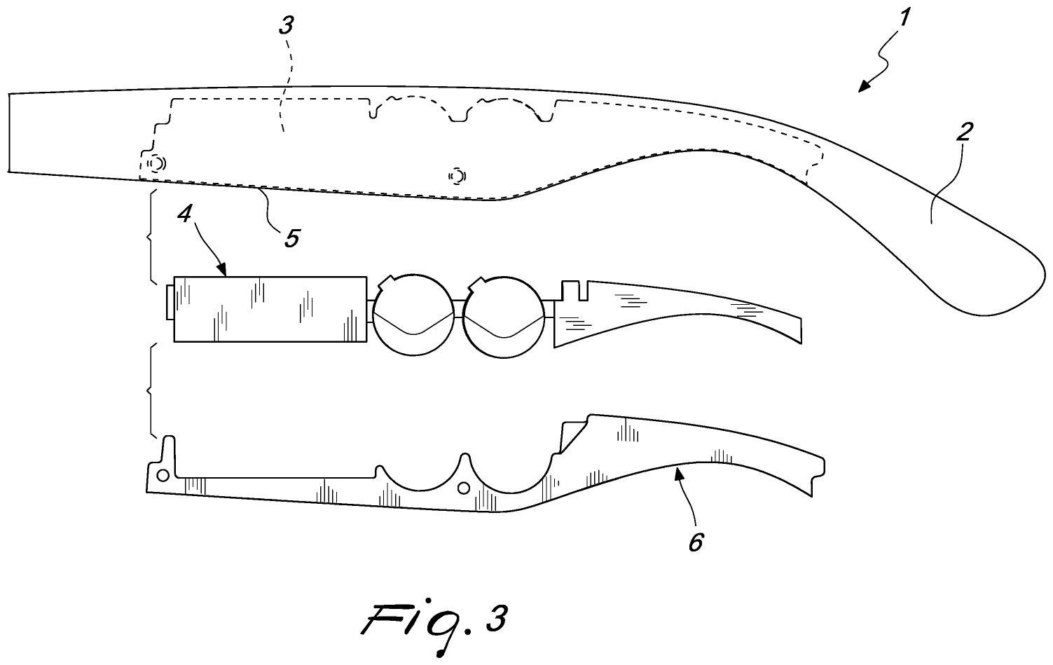

### DETAILED DESCRIPTION OF THE DRAWINGS

With reference to the figures, the temple for eyeglasses according to the present disclosure, generally designated by the reference numeral 1, comprises a temple body 2, which is provided internally with a cavity 3 adapted to accommodate electronic components 4 designed to operate electronic eyeglasses to which the temple 1 must be coupled.

Conveniently, the cavity 3 is fanned with an opening 5 located at the bottom side of the temple.

Basically, therefore, the temple 2 has a cavity 3 with a lower opening 5 which allows the accommodation of the electronic components 4.

The cavity 3 is closed by a covering element 6 which is, for example, conveniently shaped so as to adapt to the shape of the electronic components 4, so as to adhere perfectly thereto, and seal the bottom opening 5 of the cavity 3 of the body 2 of the temple.

The covering element 6 is necessary both to retain and protect the electronic components 4 and to complete the lower profile of the body 2 of the temple from an aesthetic point of view.

The profile of the covering element 6 is, as mentioned, complementary to the profile of the electronic components 4, so as to retain the electronic components 4 and thus render them integral with the covering element 6, which at the same time has the function of sealing the cavity or compartment 3 of the temple body 2.

The cavity or compartment 3 containing the electronic components 4 can be sealed only at the internal walls of the cavity 3. It is not necessary to have an interface for gluing (abutment) between the temple body 2 and the covering element 6, which protrudes beyond the perimeter of the cavity 3 when looking at the cavity 3 from the bottom upward.

This allows to reduce the impact of the assembly on the entire width of the temple with respect to the lower view.

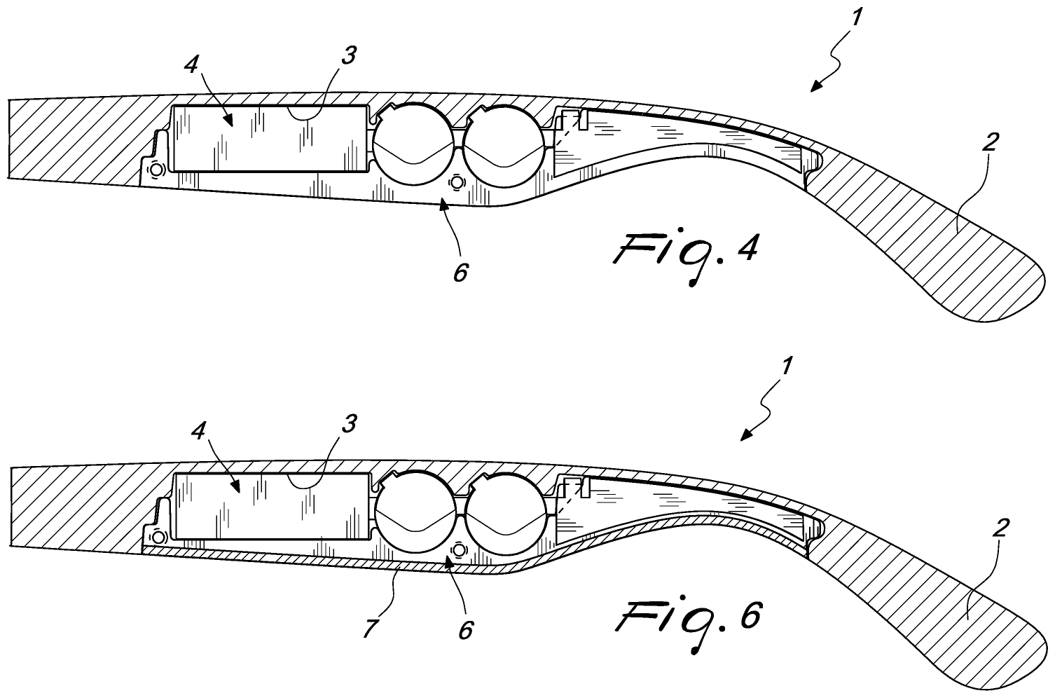

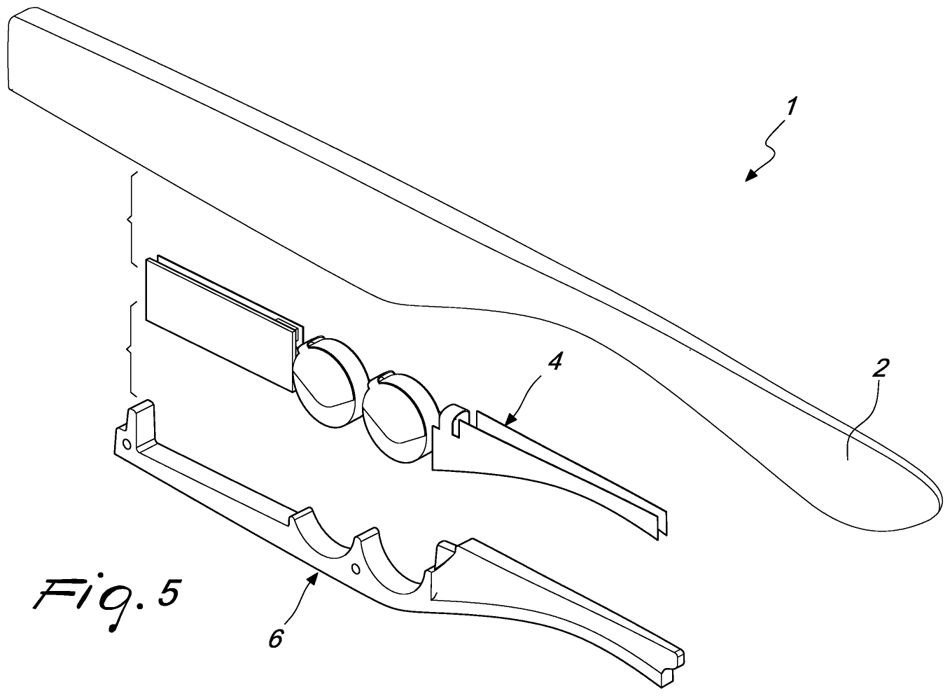

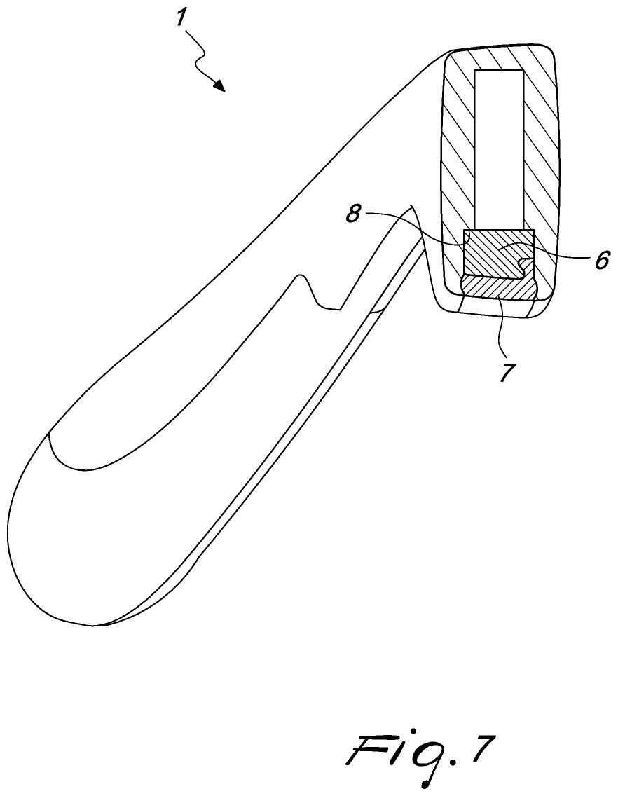

A constructive variation, shown in FIG. 6, consists of the application of a layer of overmolded material 7, between the covering element 6 that supports and sustains the electronic components 4 and the temple body 2. In this case, the covering element 6 that supports the electronic components 4 is slightly recessed with respect to the external surface of the temple body 2, so as to create a space necessary for the layer of overmolded material 7.

Specifically, the overmolded material 7 is hypoallergenic or in any case suitable for contact with the skin even of sensitive subjects such as children.

More particularly, specifically, the overmolded material can be TR90 or another polymeric material and/or rubber.

In this manner, the overmolded material 7 defines and completes the lower surface of the body 2 of the temple.

In this case, the process for overmolding the layer of material 7 is subsequent to the assembly of the electronic components 4 and of the covering element 6 that supports them.

In another embodiment, the overmolded material 7 is glued on top of the covering element 6.

The advantages deriving from this second embodiment are the fact that the cavity or compartment 3 containing the electronic components 4 is sealed, in order to increase its outward insulation.

Furthermore, in an alternative embodiment, the overmolding is assisted by construction geometries that facilitate the grip of the overmolding, such as an undercut or, more in general, gaskets. Such geometries, furthermore, further facilitate tightness and impermeableness to water.

Basically, the internal shape of the body of the temple 1 can be provided with an undercut 8 against which the covering element 6 abuts, which is then sealed by overmolding a layer of rubber 7.

As an alternative, the undercut can be constituted by gasket which is arranged inside the body of the temple and against which the covering element 6 again abuts.

In a further embodiment, it is possible to provide the undercut 8 coupled with a gasket which abuts against the undercut.

In a further embodiment, the temple is assembled by first inserting inside it the electronic components, then arranging the covering element, separately, and then sealing the covering element against the internal walls of the cavity of the temple body.

In practice it has been found that the temple for eyeglasses according to the disclosure fully achieves the intended aim and objects, since it allows to accommodate in a sealed manner the electronic components inside it, by insertion in an opening formed in a lower region of said temple body, avoiding therefore any accidental contact between the electronic components and the user.

Moreover, the covering element 6 is a covering element that is not a simple cover for closing a cavity, but is a covering element that is inserted in such cavity, occupying a part of its internal space, like a plug, thus supporting and retaining the electronic components 4 and completely sealing the cavity 3 of the temple body 2.

This allows, for example, in case of deformation at right angles with respect to the length of the temple to which the temple is subjected when is worn by a user, i.e., when the two wings of the two temples of the eyeglasses deform by moving away from each other in order to adapt to the user, to better resist this deformation because the recess perimeter forces the covering element 6 to deform together with the rest of the temple, i.e., to flex together with the body 2 of the temple.

With respect to a lateral opening formed in the body of the temple according to the known solutions, the risk of a delamination between the two component parts which, when coupled, constitute the temple body is therefore avoided.

In fact, as mentioned previously, in the case of a cover arranged on a lateral face of the temple, the shell of the temple that is affected by the cover will likely be more rigid than the one without the cover, or in any case with a different deformation, and this might lead to a delamination of the two assembled shells which together constitute the body of the temple.

This drawback does not occur with the solution according to the disclosure.

Furthermore, sealing the covering element inside the compartment or cavity is much simpler than the solution of sealing a cover of the known type, since there is no need to define a gluing abutment, as in fact it is possible to utilize for gluing the internal walls of the compartment against which the covering element abuts which is inserted like a plug into the cavity or compartment and is not simply rested so as to close it.

The temple for eyeglasses thus conceived is susceptible of further modifications and variations, all of which are within the scope of the accompanying claims.

All the details may furthermore be replaced with other equivalent elements and methods.

In practice, the materials used, as well as the contingent shapes and dimensions, may be any according to the requirements and the state of the art.

1-13. (canceled)

14. A temple for eyeglasses comprising: a temple body which is provided internally with a cavity configured for accommodating electronic components, wherein said cavity is accessible via an opening formed at a lower surface of said temple body, a covering element being adapted to close said cavity by insertion in said cavity.

15. The temple for eyeglasses according to claim 14, wherein said covering element supports and retains said electronic components.

16. The temple for eyeglasses according to claim 14, wherein said covering element has a profile that is complementary to a profile of said electronic components, so that said electronic components are supported and retained to said covering element.

17. The temple for eyeglasses according to claim 14, wherein said covering element has a profile that is configured to enter said cavity and occupy at least part of a space of said cavity and allow at the same time a seal between said covering element and internal walls of said cavity.

18. The temple for eyeglasses according to claim 14, further comprising a layer of overmolded material that is adapted to be overmolded on said covering element when said covering element is inserted in said cavity so as to close said cavity.

19. The temple for eyeglasses according to claim 14, further comprising an undercut formed at an internal shape of said temple body, said covering element abutting against said undercut.

20. The temple for eyeglasses according to claim 19, wherein said undercut is formed by a gasket.

21. The temple for eyeglasses according to claim 19, wherein said undercut is coupled with a gasket which abuts against said undercut.

22. A method for the assembly of a temple for eyeglasses according to claim 14, the method including the following steps:
coupling said covering element to said electronic components,
inserting, through said opening for access to said cavity, said covering element coupled to said electronic elements in said cavity of the body of the temple, and
sealing said covering element against said internal walls of the cavity of the body of the temple.

23. The method according to claim 22, wherein said covering element, when inserted in said cavity, is flush with adjacent surface portions of the temple body.

24. The method according to claim 22, further comprising a step of overmolding a layer of material on said covering element, in order to seal said covering element in said cavity of the temple body.

25. The method according to claim 24, wherein said covering element, when inserted in said cavity, is in a recessed position with respect to the adjacent surface portions of the temple body, said recess being filled by said layer of overmolded material.

26. A method for assembling a temple for eyeglasses according to claim 14, the method including the steps of:
inserting, through said opening for access to said cavity, said electronic components in said cavity of the body of the temple,
inserting, through said opening for access to said cavity, said covering element, separately from said electronic components, and
sealing said covering element against said internal walls of the cavity of the body of the temple.
